(19) United States
(12) Patent Application Publication
(10) Pub. No.: US 2002/0026372 A1
(43) Pub. Date: Feb. 28, 2002

(54) Delivery support server and delivery support system

(76) Inventor: Shinya Katsuta, Gunma (JP)

Correspondence Address: LYON & LYON LLP, 633 WEST FIFTH STREET, SUITE 4700, LOS ANGELES, CA, 90071, US

(21) Appl. No.: 09/823,849

(22) Filed: Mar. 30, 2001

(30) Foreign Application Priority Data
Aug. 24, 2000 (JP) 2000-254696

(51) Int. Cl. G06F 17/60

(52) U.S. Cl. 705/26

(57) ABSTRACT

A delivery support server and a delivery support system for electronically supporting delivery of goods in a series of delivering processes. A user data registration unit registers user data which includes a plurality of individual data items on a user, for a series of the delivery processes. A user ID issuing unit issues a user ID when the user data are registered. When a delivering agent requests an inquiry of user data or recipient data by using the user ID, recipient ID or order number, a data presenting unit selects and presents individual data items that the delivering agent needs in carrying out the delivering business only, from a series of the delivering processes. Only the minimum amount of information necessary for delivering the goods is known to the delivering agent.

### BACKGROUND OF THE INVENTION

1. Field of the Invention

The present invention relates to a delivery support technology, and it particularly relates to a server and a system which support the delivery of goods from a user who dispatches it to a recipient of the goods.

2. Description of the Related Art

In the conventional delivery system, when a sender wishes to send out goods to a recipient, the sender writes individual data such as the names, addresses and telephone numbers of both the sender and recipient on the goods or in a predetermined form so as to request the delivery of the goods to a delivering party. The goods handed over from the senders to the delivering party at a delivery receiving shop are once collected at a collection and delivery center and are then sorted out based on the address of the recipient. Thereafter, the goods are transported to a collection and delivery center in charge of the delivery area including the address of the recipient, and are delivered to the recipient by a delivering person.

In order for the goods to arrive at the hands of the recipient, the name and address of the recipient is all what the delivering party has to know. However, in order for the delivering party to contact the recipient if he/she was absent when the goods are delivered, the telephone number of the recipient is usually written on the outside of the goods. Moreover, in case the goods can not be delivered due to erroneously entered name or address of the recipient and thus the delivering party needs to contact the sender, the telephone number of the sender is oftentimes written on the outside of the goods.

However, in the current delivery system in which the individual data of the sender and recipient are written on the outside of the goods, there exists a risk where the individual data become known to unspecified third parties. Recently, the leakage of individual data is becoming a serious problem in our society, and the increased number of general users wish to hold their individual data secret in every aspect of daily living. Now, the individual data such as the telephone number get known to a clerk who takes care of the goods in the conventional delivery system when the sender requests the delivery of the goods at a shop. Since the recipient directly faces a delivering person, a similarly situation will occur when the recipient receives the goods from the delivering person. Such the situation might be an unwanted situation to the users including young females.

### SUMMARY OF THE INVENTION

The present invention has been made in view of the foregoing circumstance, and an object thereof is to provide a delivery support technology which significantly reduces the risk of possible leakage of individual information.

An aspect of the present invention relates to a delivery support server. This server electronically supports delivery of goods from a user who dispatches the goods to a recipient. The server includes: a user data registration unit which registers user data including a plurality of individual data items on the user, so as to perform a series of delivery processes; a user identification issuing unit which issues an user identification when the user data registration unit registers the user data; and a data presenting unit which indicates the individual data items necessary on a delivering party's part among the series of delivery processes by selecting the items from the user data, after the delivering party engaged in delivery of the goods requests an inquiry of the user data by using the user identification.

As examples of the “individual data items” there are name, address, telephone number, e-mail address and so forth. As examples of “a series of delivery processes” there are processes which include a receiving of goods, collection and delivery, transportation, delivery of the goods to the hands of a recipient, and so forth. The data presenting unit selects the individual data items necessary only for an appropriate person in charge of certain step in a series of delivery processes, and presents the selected data to each person engaged in a series of the delivery processes. For example, since a person in charge of receiving the goods does not need to know the telephone number of a sender, the data presenting unit does not present it to the person while only a minimum amount of individual data necessary for confirming data on the delivery, such as name and address, is presented.

Moreover, the delivery support server may further include: a delivery request receiving unit which receives a request of delivery of the goods from the user; a recipient data registration unit which, upon request of the delivery, prompts to register recipient data including a plurality of individual data items on the recipient; and an order number issuing unit which issues an order number of delivery when the recipient data are registered and an order the delivery is confirmed; wherein the data indicating unit may indicate or present the individual data items necessary on the delivering party's part among the series of delivery processes by selecting the items from the recipient data when the delivering party requests an inquiry of the recipient data by using the order number. By implementing this structure, disclosure of the individual data on the recipient as well as the sender can be suppressed to the minimum.

The recipient data include an electronic mail address of the recipient, and the delivery support server may further include a notification unit which notifies data on the delivery to the electronic mail address when the order is confirmed. By notifying a recipient of a scheduled date of the delivery prior to the actual delivery, a chance of absence of the recipient at the time of the actual delivery can be significantly reduced or avoided.

Moreover, the delivery support server may further include: a recipient data registration unit which registers recipient data including a plurality of individual data items on the recipient; and a recipient identification issuing unit which issues a recipient identification when the recipient data registration unit registers the recipient data, wherein the data presenting unit may indicate the individual data items necessary on the delivering party's part among the series of delivery processes by selecting the items from the recipient data when the delivering party requests an inquiry of the recipient data by using the recipient identification. By issuing also the identification to the recipient data, the registration of the recipient data can be omitted when another goods are delivered to the same recipient. When the recipient already has a user identification, said user identification may be used as the recipient identification.

Moreover, the delivery support server may further include a data conversion unit which sends the recipient data by encoding at least a part of said recipient data when an inquiry of the recipient data is received from the delivering party. As an example of the encoding, the data conversion unit may convert the data into a bar code, so that leakage of the individual data to a third party can be suppressed to the minimum or completely avoided.

Moreover, the delivery support server may further include a telephone transfer unit which connects a telephone line of the delivering party to a telephone line of the recipient while a telephone number of the recipient is concealed from the delivering party, upon receipt of a request that the delivering party wishes to inquire of the recipient. Thus, the delivering party can communicate with the recipient while the telephone number of the recipient is concealed from the delivering party.

Another aspect of the present invention relates to a delivery support system. The delivery support system includes a delivery support server that electronically supports delivery of goods from a user who dispatches the goods to a recipient; and a delivering party's terminal which is available to a delivering party that delivers the goods. Said delivery support server includes: a recipient data registration unit which registers recipient data including a plurality of individual data items on the recipient; and a data conversion unit which converts and sends the recipient data by encoding at least a part of said recipient data. Said delivering party's terminal includes an encoded data reading unit which reads a telephone number of the recipient from the encoded recipient data so as to telephone the recipient.

Moreover, any arbitrary combination of the above-mentioned structural components in the present invention is still effective as an embodiment of the present invention when applied as apparatus, a method, a system, a computer program and so forth.

Moreover, this summary of the invention does not necessarily describe all necessarily features so that the invention may also be sub-combination of these described features.

### BRIEF DESCRIPTION OF THE DRAWINGS

FIG. 1 illustrates a structure of a delivery support system 10 according to an embodiment of the present invention.

FIG. 2 is a chart showing a series of delivery processes in the deliver support system 10 where the goods are delivered from the user 14 to the recipient 24.

FIG. 3 shows an internal structure of the delivery support server 12.

FIG. 4 is a table showing an example of data stored in the user information database T1.

FIG. 5 is a table showing an example of data stored in the delivery information database T2.

FIG. 6 shows a user data registration screen 400 displayed on the user terminal 14 by the user data registration unit 110.

FIG. 7 shows a user registration completion screen 420 displayed on the user terminal 14 by the user ID issuing unit 112.

FIG. 8 shows a delivery receipt screen 430 displayed on the user terminal 14 by the delivery receiving unit 120.

FIG. 9 shows a recipient data registration screen 440 displayed on the user terminal 14 by the recipient data registration unit 122.

FIG. 10 shows a delivery temporary receipt completion screen 460 displayed on the user terminal 14 by the order number issuing unit 124.

FIG. 11A shows an example of a data inquiry screen 470 displayed on the delivery receiving shop's terminal 16 by the data inquiring unit 140.

FIG. 11B shows an example of a data presenting screen 480 displayed on the delivery receiving shop's terminal 16 by the data presenting unit 142.

### DETAILED DESCRIPTION OF THE INVENTION

The invention will now be described based on the preferred embodiments, which do not intend to limit the scope of the present invention, but exemplify the invention. All of the features and the combinations thereof described in the embodiment are not necessarily essential to the invention.

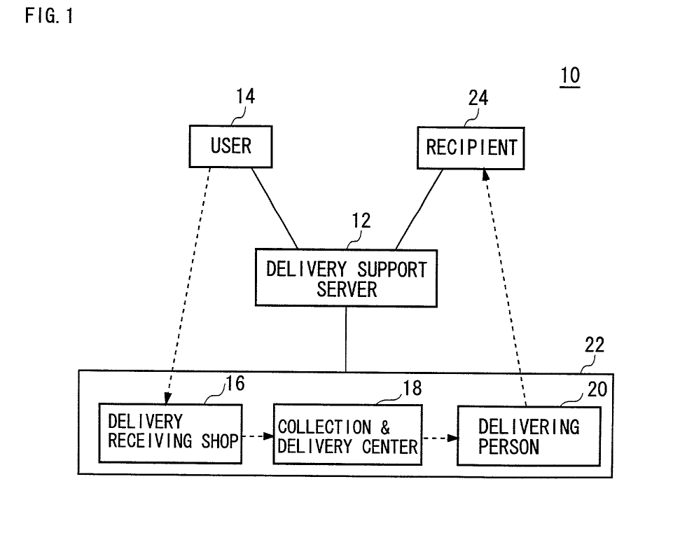

FIG. 1 illustrates a structure of a delivery support system 10 according to an embodiment of the present invention. When a term “user” appears in this patent application, the user himself/herself and a terminal of the user are not specifically distinguished. Similarly, when a “recipient” is used, the recipient himself/herself and a terminal of the recipient are not specifically distinguished. Similarly, a “delivering party” or “delivering agent” is used, the delivering party itself and a terminal of the delivering party are not specifically distinguished. Moreover, the “delivering party” may be used to mean any one of a delivering agent, a shop and a person in charge of the delivery, and they are not specifically distinguished therefrom.

In the delivery support system 10, a delivery support server 12 which electronically supports the delivery of goods, a user terminal which a user 14 as a sender uses to access the delivery support server 12, a delivery party's terminal which a delivering party 22 engaged in the delivery of the goods uses to access the delivery support server 12, and a recipient's terminal which a recipient uses to access the delivery support server 12 are all connected to a network which means the Internet here.

The delivering party 22 includes business personnel engaged in a series of the delivering process and a person in charge of the delivery. Here, the delivering party 22 also includes a delivery receiving shop 16 which receives delivering goods from the user 14, a collection and delivery center 18 which collects the delivering goods from the delivery receiving shop 16 and transports it, and the delivering person 20 who delivers the delivering goods which is transported to the collection and delivery center 18, to the recipient 24.

Dotted lines shown in FIG. 1 shows a path through which the goods are delivered. First, the user 14 hands over the goods to be delivered, to the delivery receiving shop 16. The delivering goods handed over to the delivery receiving shop 16 are once collected at the collection and delivery center 18, and sorted out based on the address of the recipient. Then, the goods are transported to a collection and delivery center 18 which is in charge of delivering goods in a specific area including the address of the recipient, and are then delivered to the recipient 24 by the delivering person 20.

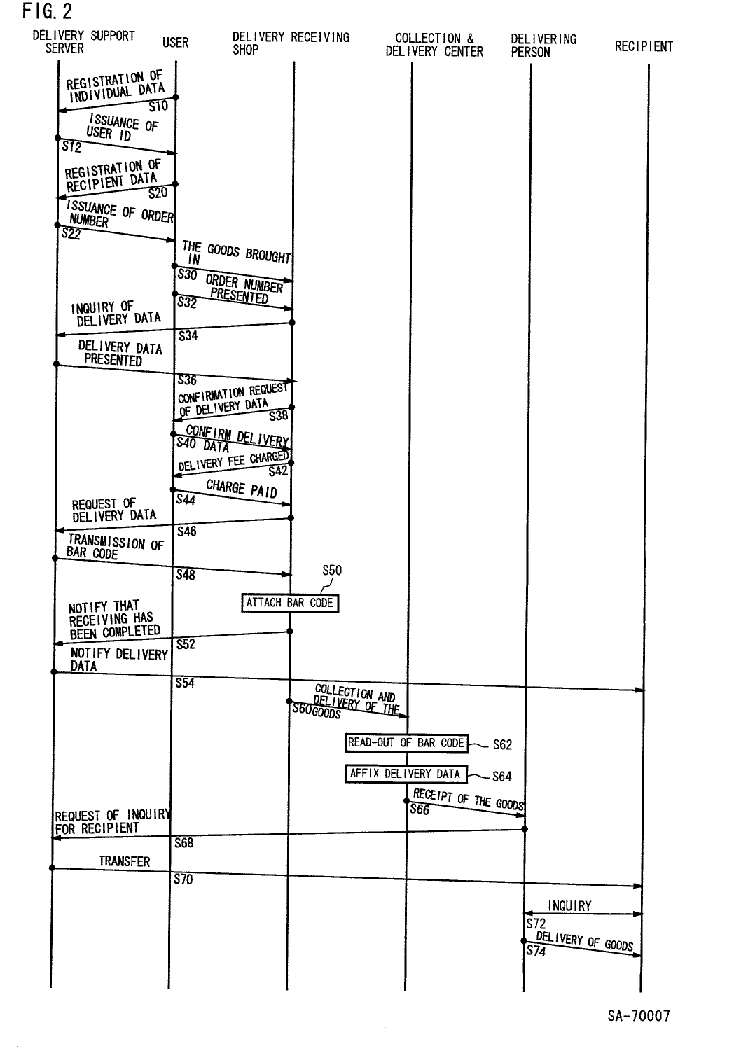

FIG. 2 is a chart showing a series of delivery processes in the delivery support system 10 where the goods are delivered from the user 14 to the recipient 24. The delivery processes are outlined in terms of interrelationships between the delivery support server 12, the user 14, the delivery receiving shop 16, the collection and delivery center 18, the delivering person 20 and the recipient 24. Further details will be described at a later stage.

Referring to FIG. 2, the user registers, in advance, his/her personal information in the delivery support server 12 (S10). Then, after the delivery support server 12 confirms that such individual items are duly registered, the delivery support server 12 issues a user ID to identify the user (S12). This completes the user registration. The user registration is need only at the outset, and the user registration will be omitted when the user who has already had the user ID requests a delivery.

Next, in order to request a delivery support of the delivery support server 12, the user registers individual data of a recipient (S20). Then, after the delivery support server 12 confirms that the individual data items necessary for a series of delivery processes are registered, the delivery support server 12 issues an order number (S22). This completes a temporary receipt of the delivery.

The user brings in the goods to the delivery receiving shop (S30), and the user presents the order number to a clerk (S32). The clerk at the delivery receiving shop uses the order number to inquire of the delivery support server 12 about delivery data (S34). The delivery support server 12 selects and presents an individual data item necessary for the delivery receiving shop to carry out a business, from the data registered (S36). The clerk requests the user to confirm the individual data item in order to check that the order number the user presented is correct (S38). The user checks the individual data item presented and tells the clerk whether or not the individual data item is correct (S40).

The clerk calculates fee based on data such as the size, weight of the goods and the address of the recipient and so forth, and charges it to the user (S42). The user pays the charged fee to the clerk (S44). The clerk again inquires of the delivery support server 12 about the delivery data (S46).

The delivery support server 12 converts data of the sender and recipient into a bar code and sends them (S48). The clerk prints out the bar code thus sent and attaches it to the delivering goods (S50), and notifies the delivery support server 12 to the effect that the receipt of the delivery has been completed (S52). The delivery support server 12 notifies the recipient of the data on the delivery (S54). This completes the receipt of the delivery.

The delivering goods brought into the delivery receiving shop 16 are collected at the collection and delivery center 18 (S60). The collection and delivery center 18 reads out the bar code attached to the delivering goods (S62) and prints out the delivery data such as the names of the sender and recipient and their addresses, and attaches them to the delivering goods (S64). Here, if the collection and delivery center 18 does not take care of the area including the address of said recipient, the delivering goods will be transported to a collection and delivery center in charge of delivering goods to a specific area including the address of said recipient.

Next, the delivering person 20 receives the delivering goods from the collection and delivery center 18 (S66), and delivers the goods to the recipient (S74). Then, if the delivering person 20 needs to contact the recipient, he requests such an inquiry from the delivery support server 12 (S68). The delivery support server 12 transfers a call from the delivering person 20, to the recipient while the telephone number of the recipient is concealed from the delivering person 20 (S70). Thereby, the delivering person 20 can ask the recipient about the convenient date and time and so on for the delivery (S72). The above are a series of delivery processes.

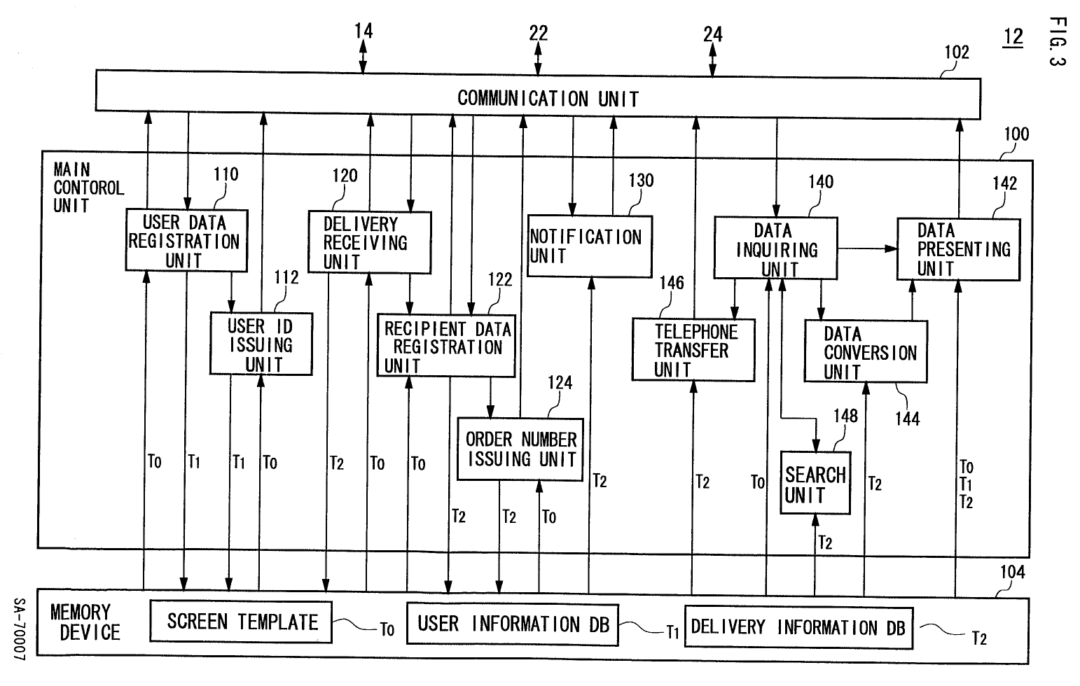

FIG. 3 shows an internal structure of the delivery support server 12. In terms of hardware components, the delivery support server 12 is usually comprised of and realized by a CPU, a memory of arbitrary computer and a program having a delivery support function loaded with the memory, and so forth, and it is to be noted that FIG. 3 shows a function-oriented block diagram realized by those in combination. Thus, it is to be understood by those skilled in the art that such the structure may be realized by hardware alone, software alone or those in combination in various forms.

The delivery support server 12 is mainly comprised of a main control unit 100, a communication unit 102 and a memory device 104, and functions as a Web server. The communication unit 102 exchanges data between the main control unit 100, a user terminal 14, a delivering party's terminal 22 and a recipient's terminal 24. The communication unit 12 is equipped with hardware such as a modem required for the communication, a driver for controlling the communication and other programs.

Various data and tables are stored in the memory device 194. A screen template T0 stores screen data supplied to the user terminal 14, delivering party's terminal 22 and recipient's terminal 24, as text data written in the markup languages such as HTML and XML while the delivery support server 12 functions as the Web server.

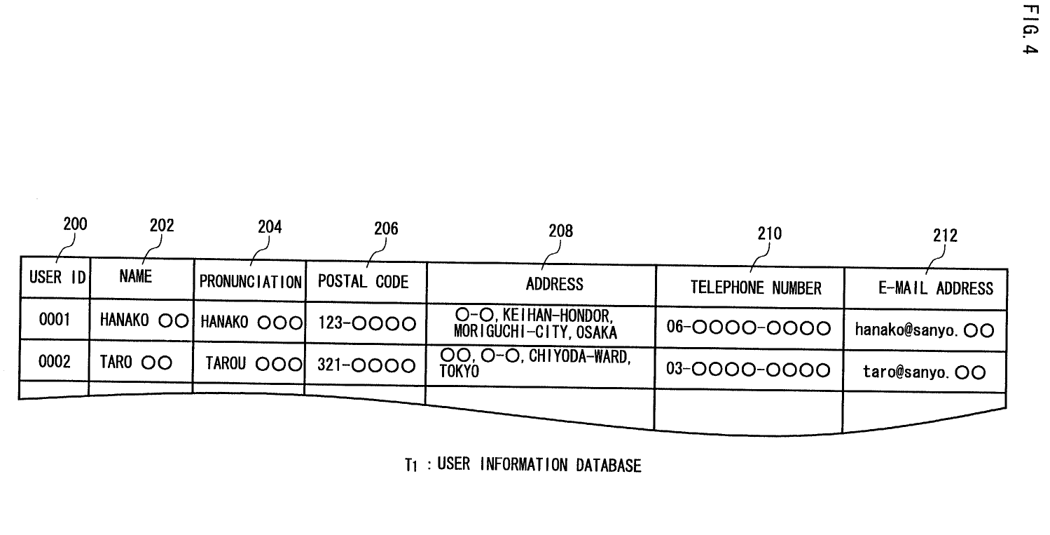

A user information database T1 stores user data which include a plurality of individual data items on the user utilizing the delivery support server 12. FIG. 4 shows an exemplary structure of data stored in the user information database T1, where there are provided a user ID column 200, a name column 202, a pronunciation column 204, a postal code column 206, an address column 208, a telephone number column 210 and an e-mail address column 212. In the user information database T1, the individual data items such as the name registered by the user and the user ID issued by the delivery support server 12 are stored in a manner that corresponds to each other. For example, as user's individual data for the user ID “0001”, registered are the name “Hanako ∘∘”, the pronunciation “hanako∘∘∘”, the postal code “123-∘∘∘∘”, the address “∘-∘, Kyosaka-Hondoori, Moriguchi City, Osaka”, the telephone number “06-∘∘∘∘-∘∘∘∘”, and the electronic mail address “hanako@sanyo.∘∘”.

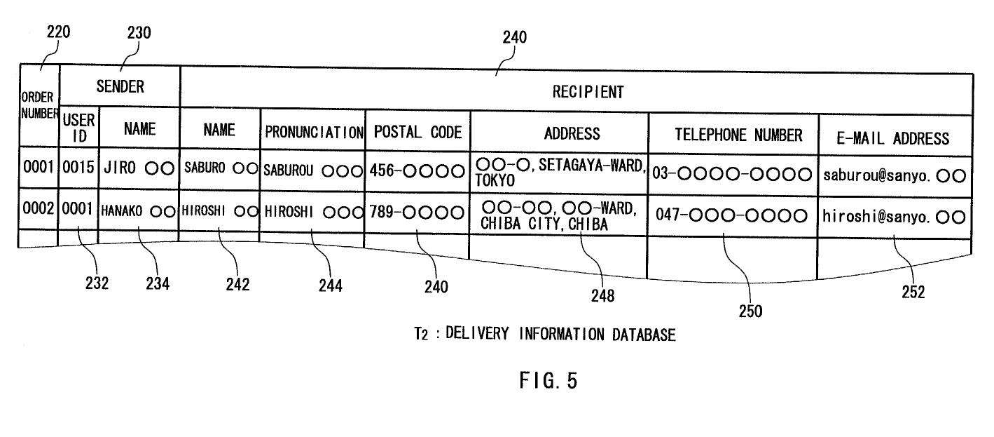

A delivery information database T2 stores data on the delivery requested by the user. FIG. 5 shows an exemplary structure of data stored in the delivery information database T2, where there are provided an order number column 220, a sender data column 230 and a recipient data column 240. A user ID column 232 and a name column 234 are provided in the sender data column 230. A name column 242, a pronunciation column 244 and a postal code column 246 and an address column 248 and a telephone number column 250 and an e-mail address column 252 are provided in the recipient data column 240. In the delivery information database T2, the data on the sender and the recipient registered by the user, and the order number issued by the delivery support server 12 are stored in a manner that corresponds to each other. For example, as delivery data for the order number “0001”, registered are the name of the sender “Jiro∘∘”, the name of recipient “Saburo∘∘”, the pronunciation of the recipient “saburou∘∘”, the postal code of the recipient “456-∘∘∘∘”, the address of the recipient “∘-∘∘, Setagaya-Ward, Tokyo”, the telephone number of the recipient “03-∘∘∘∘-∘∘∘∘” and the e-mail address of the recipient “saburo@sanyo.∘∘”.

Referring to FIG. 3, the user data registration unit 110 reads out a screen which prompts the registration of the user data, from the screen template T0, so as to display it on the user terminal 14 via communication unit 102. The user data registration unit 110 have the CGI functioning therein, so that the data the user inputted according to the guidance displayed on the screen are recorded in the user information database T1. When it is confirmed that the user has registered the individual data items necessary for a series of the delivery processes, the user data registration unit 110 allows the user ID issuing unit 122 to issue a user ID. The user ID is recorded in the user information database T1 in a manner such that the user ID is associated with the user data. The user ID issuing unit 112 displays a screen for conveying the issued user ID to the user.

The user ID may differ from one another for every user ID. Thus, the user can be identified by the user ID alone. However, both the user ID and the name of user may be used. In that case, the user ID will be used when there are users having the same surname and given names, so as to reduce the digits of the user ID. Thus, chances of forgetting the ID or inputting a mistaken ID will be diminished. The user ID may be stored as cookies of a browser in the user terminal 14.

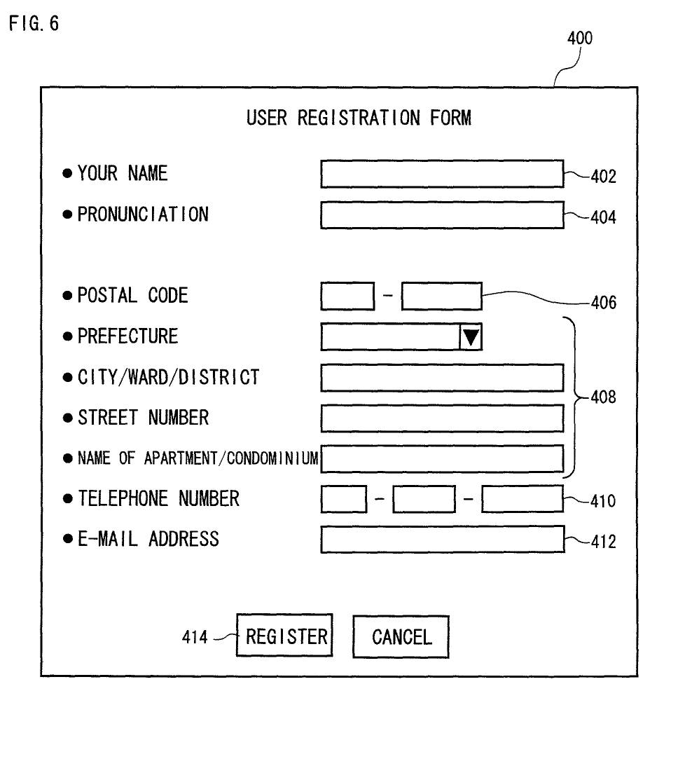

FIG. 6 shows a user data registration screen 400 displayed on the user terminal 14 by the user data registration unit 110. In the user registration screen 400, provided are a name entry column 402, a pronunciation entry column 404, a postal code entry column 406, an address entry column 408, a telephone number entry column 410 and an e-mail address entry column 412. When the user inputs his/her individual data in each field and clicks on a registration button 414, each input value is registered to the user information database T1 by the CGI function of the user data registration unit 110, so as to issue the user ID.

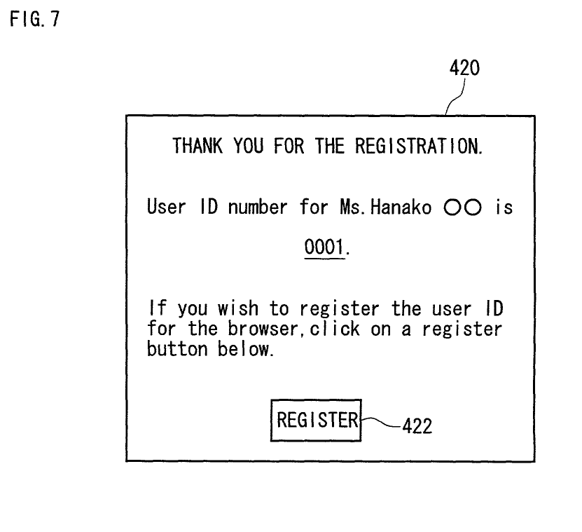

FIG. 7 shows a user registration completion screen 420 displayed on the user terminal 14 by the user ID issuing unit 112. The user ID issued by the user ID issuing unit 112 is displayed on the user registration completion screen 420. In FIG. 7, for example, the user ID “0001” of the user “∘∘Hanako” is displayed. The user can register the user ID as cookie data for the browser, by clicking on a registration button 422.

The delivery receiving unit 120 reads out a screen containing a request from the user for delivery of the goods, from the screen template T0, so that the screen is displayed on the user terminal 14 via the communication unit 102. When the delivery receiving unit 120 receives the request from the user for delivery of the goods, a recipient data registration unit 122 reads out a screen which serves to prompt the user to register the recipient data, from the screen template T0, so as to be displayed on the user terminal 14. The delivery receiving unit 120 and the recipient data registration unit 122 have the CGI functions therein, so that the data on the sender and recipient that the user inputted according to the guidance displayed on the screen are recorded in the delivery information database T2.

When the recipient data registration unit 122 confirms the registration of the individual data items, an order number issuing unit 124 issues the order number, and records this order number in the delivery information database T2 in a manner such that the data on the sender are associated with data on the recipient. The order number issuing unit 124 displays a screen for conveying the order number issued to the user.

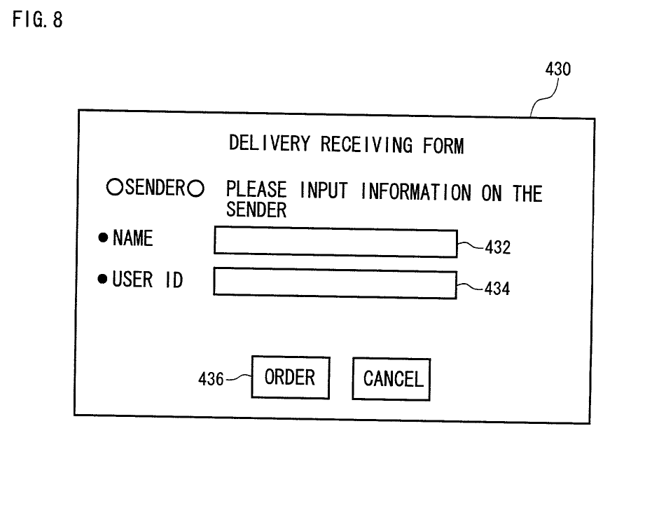

FIG. 8 shows a delivery receipt screen 430 displayed on the user terminal 14 by the delivery receiving unit 120. A sender's name entry column 432 and a sender's user ID entry column 434 are provided in the delivery receipt screen 430. When the user inputs his/her own individual data in each field and clicks on an order button 436, each input value is registered in the delivery information database T2 by the delivery receiving unit 120, and a recipient data registration screen 440 appears next.

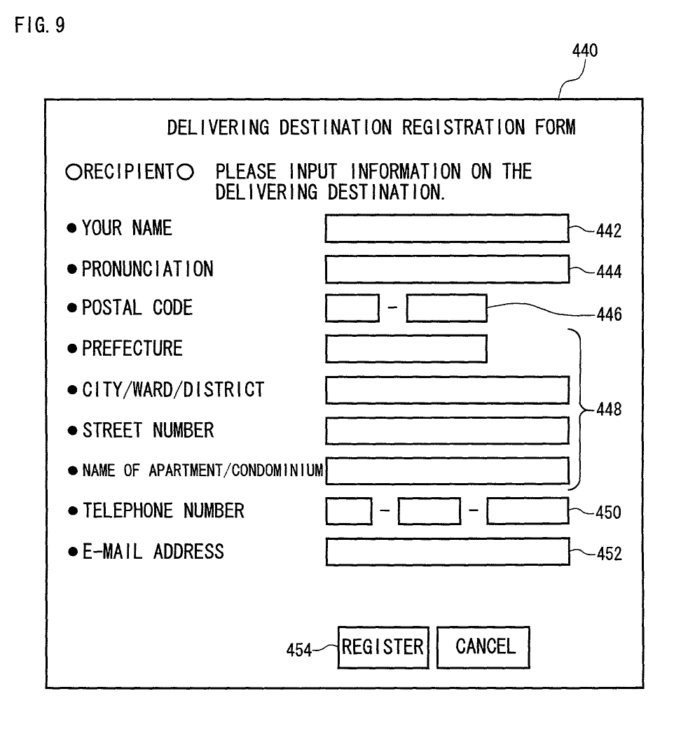

FIG. 9 shows the recipient data registration screen 440 displayed on the user terminal 14 by the recipient data registration unit 122. In the recipient data registration screen 440, provided are a name entry column 442, a pronunciation entry column 444, a postal code entry column 446, an address entry column 448, a telephone number entry column 450 and an e-mail address entry column 452. When the user inputs individual data of the recipient in each field and clicks on a registration button 454, each input value is registered to the delivery information database T2 by the CGI function of the recipient data registration unit 122, so as to issue the order number.

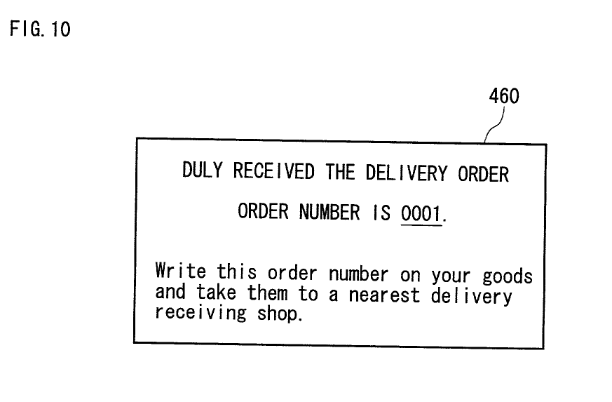

FIG. 10 shows a delivery temporary receipt completion screen 460 displayed on the user terminal 14 by the order number issuing unit 124 when the recipient data are registered and the order of a delivery is confirmed. An order number “0001” issued by the order number issuing unit 124 is displayed on the delivery temporary receipt completion screen 460. Upon confirmation of the delivery order a notification unit 130 reads out an e-mail address of the recipient from the delivery information database T2, and sends the delivery data to the e-mail address. For example, the notifications unit 130 notifies the recipient, in advance, about scheduled delivery date and time. If the recipient will be absent on the scheduled delivery date, the delivering party may be notified of the absence of the recipient via e-mail. In that case, the e-mail may be exchanged through the delivery support server 12 serving as an intermediary e-mail distributor while the e-mail address of the recipient is concealed from the delivering agent.

In FIG. 2, the timing at which the notification unit 130 notifies the recipient is the time when the delivery receiving shop completes the receipt. This is so because a scheduled delivery date might be delayed if there is a delayed period of time between the temporary receipt made to the delivery support server 12 by the user and the time when the delivering goods are actually brought into the delivery receiving shop. The recipient may be notified of data not affected by the time lag between the temporary receipt and the actual receipt, such as a sender's name and address when the user registers the recipient data and the temporary receipt has been completed. When e-mail of the recipient is not registered, notification may be made by a telephone call.

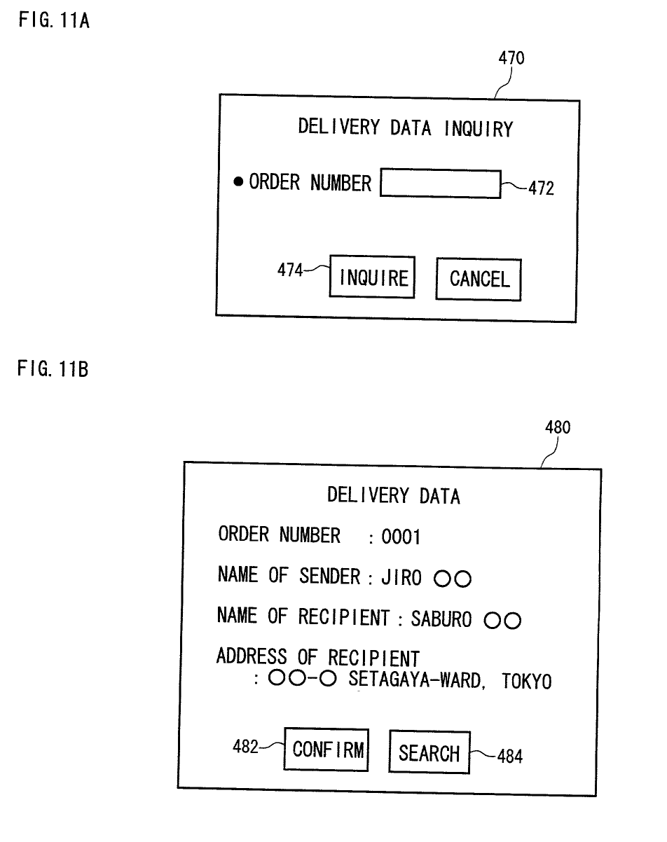

A data inquiring unit 140 reads out a screen provided for receiving a data inquiring request from the user terminal 14, delivering party's terminal 22 and recipient's terminal 24, from the screen template T0 so as to be displayed. Upon receipt of the data inquiring request, the instruction is transmitted to a data presenting unit 142, a data conversion unit 144, a telephone transfer unit 146 and a search unit 148 according to need. When the delivering agent requests an inquiry of user data or recipient data by using the user ID, recipient ID or order number, the data presenting unit 142 selects individual data items that the delivering agent needs in carrying out the business, from a series of the delivering processes, and reads out a screen from the screen template T0 and presents it to the delivering party. A method of selection will be described in detail in FIGS. 11A and 11B.

When the data conversion unit 144 receives the user data or an inquiry from the delivering party, the data conversion unit 144 encodes part of the data. In the present embodiment, the telephone number of the recipient is converted to a bar code. Thereby, the delivering processings can be performed while the telephone number of the recipient is concealed from the delivering person. When the delivering person wishes to contact the recipient, he/she can call the recipient by using the delivering party's terminal equipped with bar code reading capability (as will be described later). Alternatively, the delivering person may request the delivery support server 12 to inquire of the recipient, by telephone so that the delivery support server 12 can transfer the telephone call to the recipient.

When the telephone transfer unit 146 receives a request to the effect that the delivering party wishes to inquire of the user or recipient, the telephone transfer unit 146 connects the telephone line of the delivering party to the telephone line of the user or recipient while the telephone number of the user or recipient is concealed from the delivering party.

The search unit 148 searches the delivery information database T2 by using the sender's name and recipient's name and so forth as a key word. For example, when the order number that the user presented to the delivery receiving shop is found wrong, a correct order number will be searched from the delivery information database T2.

FIGS. 11A and 11B illustrate delivery data inquires in a delivery receiving shop's terminal 16. These correspond to S34 and S36 shown in FIG. 2. FIG. 11A shows an example of a data inquiry screen 470 displayed on the delivery receiving shop's terminal 16 by the data inquiring unit 140. An order number entry column 472 is provided in the data inquiry screen 470. A clerk at the delivery receiving shop enters the order number presented by the user in the order number entry column 472, and clicks on an inquiry button 474 so as to make an inquiry.

Though the inquiry is addressed to the delivery support server 12 by using the order number in the present embodiment, the inquiry using the order number is not specifically distinguished from the inquiry using the user ID in this patent application since the order number is linked to the user ID in the delivery support database T2. This also applies to the case with the recipient ID.

FIG. 11B shows an example of a data presenting screen 480 displayed on the delivery receiving shop's terminal 16 by the data presenting unit 142. The order number, the name of the sender, the name of the recipient and the address of the recipient are displayed on the data presenting screen 480. Namely, the data presenting unit 142 selects the name of the sender, the name of the recipient and the address of the recipient from the registered individual data items, and presents the thus selected data items to the delivery receiving shop's terminal. The clerk at the delivery receiving shop checks to see if these data are correct or not. At the delivery receiving shop it suffices to confirm that the order number the user presented is correct, and there is no need to know the telephone number of the user and recipient. Thus, the user can request the delivery at the shop while the address and telephone number are concealed from the clerk at the delivery receiving shop.

In the above embodiment, the name of the sender and the name of the recipient and the address of the recipient are presented in order to confirm the order number. The combination of the individual data items to be presented are not limited to this, and anything by which whether the order is correct or not can be checked will suffice. For example, whether the order number is correct or not may be checked by the user ID instead of the name of the sender, so that the delivering goods can be received by the delivering receiving shop without the individual data being known to the shop at all.

When the order number the user presented is found wrong, clicking on a search button 484 prompts a search screen. Then, information such as the name of the sender, the name of the recipient and so on is inputted in the search screen, so as to search a correct order number.

When the order number the user presented is correct, a delivery data request is transmitted to the delivery support server 12 again by clicking on a confirm button 482. Then, the delivery support server 12 converts the names, addresses and telephone numbers of both the sender and recipient, into the bar code and transmits the bar code to the delivery receiving shop's terminal 16. The delivery receiving shop's terminal prints out the bar code received from the delivery support server 12. The clerk at the delivery receiving shop affixes the printed bar code to the delivering goods.

The collection and delivery center's terminal 18 has functions by which the bar code affixed in the delivering goods is read and the names and addresses of the sender and recipient are printed out. Thereby, the delivering person can deliver the goods to the recipient based on the name and address of the recipient. The recipient can know who sent the goods, from the name and address of the sender. It is to be noted that there is no need of specifying the telephone number on a printout and said telephone number may remain in the form of bar-coded data.

A delivering person's terminal 20 includes an encoded data read-out unit which reads the telephone number of the sender or the recipient from the bar coded affixed to the delivering goods, and which dials one of the telephone numbers. Thus, the delivering party can communicate with the recipient or the user while the telephone number of both/either the recipient and/or the user is concealed from the delivering party.

In the delivery support system according to the present embodiments, only the minimum amount of information necessary for performing the delivering business is disclosed to each of the parties in charge of performing a series of the delivery processings, so that leakage of the individual data can be suppressed to the minimum degree.

The present invention has been described based on various embodiments which are only exemplary. It is understood by those skilled in the art that there exist other various modifications to the combination of each component and each processing described and that such modifications are encompassed by the scope of the present invention.

As one of the modifications, a recipient ID may be given for the registered recipient data, in the similar manner that the user ID is given for the registered user data. In that case, a recipient information database will be added in the memory device 104 shown in FIG. 3. The contents of the recipient information database will be similar to those of the user information database T₁, and the recipient ID's and individual data items of the recipients are stored in the corresponding manner. Instead of the individual data items of the recipients, the recipient ID's are stored in the delivery information database T2.

By implementing the above structure, time otherwise spent for registering the recipient is saved when sending the goods again to the recipient who has been already registered. In the case where a recipient already has a user ID, time otherwise spent for registration is saved by using said user ID as the recipient ID.

In the above embodiment according to the present invention, the delivery data are bar-coded and attached to the goods at the delivery receiving shop. The timing at which the delivery data are bar-coded is not limited to this, and for example, the user himself/herself may bar-code the delivery data and attach it to the goods, and the bar code may be attached by accessing the delivery support server 12 at the collection and delivery center. Moreover, the goods may be managed by using the order number throughout the whole processing without going through such a bar-coding process.

Though the delivering goods are handled and managed by use of the order number in the present embodiment, the user ID or the recipient ID may be written on the goods. Moreover, instead of acquiring the order number on every occasion of delivery, writing only the once acquired user ID to the goods conceals own individual data from third parties. Similarly, writing only the once acquired recipient ID protects the recipient's individual data. By implementing such a system, a user who usually do not use a personal computer at home and thus can not easily access the delivery support server 12 can also benefit from the advantages the system offers, by once acquiring a user ID in whatever way possible.

Though the terminal through which the user accesses the delivery support system 12 is expressed as the user terminal in the present embodiment, this terminal may be provided at the delivery receiving shop. When the user brings in the goods to the delivery receiving shop, user registration and delivery ordering may be carried out by using the terminal provided at the delivery receiving shop, so that the present system can be used by the user who does not have a terminal accessible to the delivery support system 12.

According to the present embodiments, provided is a reliable delivering technology which minimizes the risk of leakage of individual data to the third parties.

Although the present invention has been described by way of exemplary embodiments, it should be understood that many changes and substitutions may be made by those skilled in the art without departing from the spirit and the scope of the present invention which is defined by the appended claims.

What is claimed is:

1. A delivery support server which electronically supports delivery of goods from a user who dispatches the goods to a recipient, the server comprising:
a user data registration unit which registers user data including a plurality of individual data items on the user, so as to perform a series of delivery processes;
a user identification issuing unit which issues an user identification when said user data registration unit registers the user data; and
a data presenting unit which indicates the individual data items necessary on a delivering party's part among the series of delivery processes by selecting the items from the user data, after the delivering party engaged in delivery of the goods requests an inquiry of the user data by using the user identification.

2. A delivery support server as recited in claim 1, further comprising:
a delivery request receiving unit which receives a request of delivery of the goods from the user;
a recipient data registration unit which, upon request of the delivery, prompts to register recipient data including a plurality of individual data items on the recipient; and
an order number issuing unit which issues an order number of delivery when the recipient data are registered and an order the delivery is confirmed;
wherein said data presenting unit indicates the individual data items necessary on the delivering firm's part among the series of delivery processes by selecting the items from the recipient data when the delivering firm requests an inquiry of the recipient data by using the order number.

3. A delivery support server as recited in claim 2, wherein the recipient data include an electronic mail address of the recipient, and the delivery support server further includes:
a notification unit which notifies data on the delivery to the electronic mail address when the order is confirmed.

4. A delivery support server as recited in claim 1, further comprising:
a recipient data registration unit which registers recipient data including a plurality of individual data items on the recipient; and
a recipient identification issuing unit which issues a recipient identification when said recipient data registration unit registers the recipient data,
wherein said data presenting unit indicates the individual data items necessary on the delivering party's part among the series of delivery processes by selecting the items from the recipient data when the delivering party requests an inquiry of the recipient data by using the recipient identification.

5. A delivery support server as recited in claim 4, wherein when the recipient has already had the user identification, said user identification is used as the recipient identification.

6. A delivery support server as recited in claim 2, further comprising a data conversion unit which sends the recipient data by encoding at least a part of said recipient data when an inquiry of the recipient data is received from the delivering party.

7. A delivery support server as recited in claim 3, further comprising a data conversion unit which sends the recipient data by encoding at least a part of said recipient data when an inquiry of the recipient data is received from the delivering party.

8. A delivery support server as recited in claim 4, further comprising a data conversion unit which sends the recipient data by encoding at least a part of said recipient data when an inquiry of the recipient data is received from the delivering party.

9. A delivery support server as recited in claim 5, further comprising a data conversion unit which sends the recipient data by encoding at least a part of said recipient data when an inquiry of the recipient data is received from the delivering party.

10. A delivery support server as recited in claim 2, further comprising a telephone transfer unit which connects a telephone line of the delivering party to a telephone line of the recipient while a telephone number of the recipient is concealed from the delivering party, upon receipt of a request that the delivering party wishes to inquire of the recipient.

11. A delivery support server as recited in claim 3, further comprising a telephone transfer unit which connects a telephone line of the delivering party to a telephone line of the recipient while a telephone number of the recipient is concealed from the delivering party, upon receipt of a request that the delivering party wishes to inquire of the recipient.

12. A delivery support server as recited in claim 4, further comprising a telephone transfer unit which connects a telephone line of the delivering party to a telephone line of the recipient while a telephone number of the recipient is concealed from the delivering party, upon receipt of a request that the delivering party wishes to inquire of the recipient.

13. A delivery support server as recited in claim 5, further comprising a telephone transfer unit which connects a telephone line of the delivering party to a telephone line of the recipient while a telephone number of the recipient is concealed from the delivering party, upon receipt of a request that the delivering party wishes to inquire of the recipient.

14. A delivery support server as recited in claim 6, further comprising a telephone transfer unit which connects a telephone line of the delivering party to a telephone line of the recipient while a telephone number of the recipient is concealed from the delivering party, upon receipt of a request that the delivering party wishes to inquire of the recipient.

15. A delivery support server as recited in claim 1, wherein the user data are inputted by the user using a terminal at his/her residence or at a premise of a delivering party.

16. A delivery support system which includes a delivery support server that electronically supports delivery of goods from a user who dispatches the goods to a recipient, and a delivering party's terminal which is available to a delivering party that delivers the goods, the system comprising:
the delivery support server, including:
a recipient data registration unit which registers recipient data including a plurality of individual data items on the recipient; and
a data conversion unit which converts and sends the recipient data by encoding at least a part of said recipient data; and
the delivering party's terminal, including:
an encoded data reading unit which reads a telephone number of the recipient from the encoded recipient data so as to telephone the recipient.
